(19) United States
(12) Patent Application Publication
(10) Pub. No.: US 2003/0033087 A1
(43) Pub. Date: Feb. 13, 2003

(54) Electronic tide meter

(76) Inventor: Toshiyuki Yuzuki, Chiba-shi (JP)

Correspondence Address: ADAMS & WILKS, 31st Floor, 50 Broadway, New York, NY, 10004, US

(21) Appl. No.: 10/205,917

(22) Filed: Jul. 26, 2002

(30) Foreign Application Priority Data
Aug. 9, 2001 (JP) 2001-242057

(51) Int. Cl. G06F 19/00; G04B 19/26

(52) U.S. Cl. 702/5; 368/19; 702/2

(57) ABSTRACT

To dynamically display a tide graph. A tide level calculation unit obtains a tide level at an interval of a time set by a display time setting unit on the basis of a date/time inputted from a date setting unit, a point inputted by a point setting unit and tidal component data at this point. Then, a tide level difference calculation unit obtains a tide level difference from a difference between a maximum value and a minimum value of tide levels, a tide level range displayed by one segment is obtained by dividing this tide level difference by a segment count along a tide-level-axis, and the tide level range is changed. Accordingly, dynamic display utilizing a display area of a display unit to the full can be attained.

### BACKGROUND OF THE INVENTION

1. Field of the Invention

The present invention relates to an electronic tide meter useful for a mobile tide meter having a small display areal size such as a wristwatch and capable of dynamically displaying a tide graph irrespective of a degree of tide level difference.

2. Description of the Prior Art

The tide meter displays in graph or other forms a phenomenon that a sea level regularly periodically rises and lowers due to revolutions of the earth, the moon and the sun and rotations of the earth, and is used for knowing a condition of a tide for fishing, surfing and so forth.

FIG. 9 is an explanatory diagram showing a conventional electronic tide meter. A conventional electronic tide meter 200 is such that a display unit 201 is configured by a plurality of segments 202 arranged in matrix and displays a tide graph, wherein the axis of ordinate indicates a tide level, and the axis of abscissa indicates a time. Note that the display unit 201 is a liquid crystal panel etc. A box body 203 of a wristwatch or a mobile telephone accommodates the display unit 201.

Further, the electronic tide meter 200 previously obtains a maximum value of tide level differences from all pieces of tide data, and determines a tide range displayed by every segment 202 by dividing this tide level different by a segment count of the segments along the axis of ordinate of the graph, thereby displaying the tide level. Further, the time-axis is divided by 24 hours a day, i.e., a segment count of the segments along the axis of abscissa, a time displayed by every segment 202 is thus determined, thereby displaying the time.

Herein, the tide is influenced most by the gravitational force of the moon, wherein a tide level difference between high and low tides comes to several meters in the case of a full moon and a new moon (a so-called spring tide) and several centimeters in the case of a half moon (a so-called neap tide) in some cases. A difference therebetween is extremely large. By contrast, a display area of the display unit 201 is limited. It is therefore possible to attain dynamic display in the case of the spring tide, however, there is a problem in that the dynamic display can not be attained in the case of the neap tide because of small display of the graph which is attributed to displaying based on a maximum tide level difference.

Further, the tide level difference, if extremely small, falls within the tide range of one segment 202 and is not displayed at all on the display unit 201 in spite of an actual occurrence of the tide level difference. Moreover, there might be a case where the tide level difference is extremely small even in the spring tide depending on a point. In such a case, a problem is that the dynamic display can not be attained regardless of the spring or neap tide.

Note that what is known as means for obviating this problem is a wristwatch disclosed in JP 5-141992 A. This wristwatch schemes to, if the data exceed an upper limit of the segments on a display screen, converge the data size within the display screen by changing a display scale. This wristwatch is not, however, constructed to predict any prospective state, though targeting the data inputted afresh momentarily such as a pressure, a humidity, a temperature, and a lap time.

A next point is that a time displayable at one time is one day at the maximum, and hence the data must be displayed by sending the display on a day-by-day basis in the case of seeing a trend of the tides for several days. Therefore, when making a schedule based on the data of the tide meter, for example, in the case of desiring to go fishing within this one week and to judge which day in this week is most appropriate to fishing, there arises a problem in that it is hard to judge by comparing the daily data with each other when displaying the data for one week by sending the display on the day-by-day basis.

### SUMMARY OF THE INVENTION

In view of the above, an electronic tide meter of the present invention comprises display means for displaying a tide graph defined by a time-axis and a tide-level-axis and configured by a plurality of segments in matrix, tide level obtaining means for obtaining a tide level at an interval of a set time on the basis of a date/time and a point for obtaining the tide and tidal component data at this point, tide level difference calculating means for calculating a tide level difference from the tide levels obtained by the tide level obtaining means, and segment range changing means for obtaining a tide level range displayed by one segment by dividing the tide level difference calculated by the tide level difference calculating means by a segment count of segments along the tide-level-axis of the display means and changing the tide level range.

Next, the electronic tide meter of the present invention further comprises point-of-inflection calculating means for calculating a point of inflection at which the tide level obtained by the tide level obtaining means changes, and point-of-inflection storage means for storing the point of inflection calculated by the point-of-inflection calculating means, in which the tide level difference calculating means calculates a tide level difference from a maximum value and a minimum value of the point of inflection. The calculation of the point of inflection enables the tide level difference to be calculated from the point of inflection.

Next, in the electronic tide meter of the present invention, the point-of-inflection calculating means calculates the point of inflection of the tide level at a time interval shorter than a time interval set by the tide level obtaining means. A more accurate tide level can be calculated by setting the time interval short.

Next, in the electronic tide meter of the present invention, the tide level obtaining means obtains the tide level from the tidal component data at an interval of one hour. Note that the tide level obtaining means may properly set the time such as one hour, six hours and twenty four hours (a day). Further, the tide obtaining date/time may be set on a day basis or an hour basis. Moreover, obtaining the tide level may involve both of a calculation-based obtaining method and a method of selecting from stored pieces of tide level data.

Next, in the electronic tide meter of the present invention, the tide level obtaining means obtains a tide level from the tidal component data at an interval of a set day. The tide level is obtained on the day-by-day basis and thus displayed, whereby the user can observe a tide condition as by a bird's-eye view and is easy to detect a tide condition matching with a condition desired by the user. Note that set day may be two or more days.

Next, in the electronic tide meter of the present invention, the tide level obtaining means sets at least one of a date/time for starting obtaining from the tidal component data and a date/time for finishing obtaining from the tidal component data. Both of the starting date/time and the finishing date/time may also be set, or only any one of them may also be set. If only any one of them is set, a period such as one month or one year since the set date/time is previously set. Further, if only the starting date/time is set, the finishing date/time may be an operating date/time or the present date/time.

Then, in the electronic tide meter of the present invention, a display to display a tide graph defined by a time-axis and a tide-level-axis and configured by a plurality of segments in matrix, a tide level obtaining circuit to obtain a tide level at an interval of a set time on the basis of a date/time and a point for obtaining tide and tidal component data at said point, a tide level difference calculator to calculate a tide level difference from said tide levels obtained by said tide level obtaining circuit, and a segment range changing circuit to obtain a tide level range displayed by one segment by dividing the tide level difference calculated by said tide level difference calculator by a segment count of segments along said tide-level-axis of said display and changing said tide level range.

### BRIEF DESCRIPTION OF THE SEVERAL VIEWS OF THE DRAWINGS

A preferred form of the present invention is illustrated in the accompanying drawings in which:

FIG. 1 is a block diagram showing an electronic tide meter in an embodiment of the present invention;

FIG. 2 is an explanatory diagram showing a specific example of a display content in a display area;

FIG. 3 is an explanatory diagram showing a specific example of a display content in the display area;

FIG. 4 is an explanatory diagram showing a specific example of a display content in the display area;

FIG. 5 is an explanatory diagram showing an example of displaying only high and low tides in the display area;

FIG. 6 is an explanatory diagram showing a specific example of a display content in the display area;

FIG. 7 is an explanatory diagram showing a specific example of a display content in the display area;

FIG. 8 is a block diagram showing an electronic tide meter in a second embodiment of the present invention; and

FIG. 9 is an explanatory diagram showing a display area of a conventional electronic tide meter.

### DETAILED DESCRIPTION OF THE PREFERRED EMBODIMENTS

The present invention will hereinafter be described in detail with reference to the drawings. Note that the present invention is not limited to the embodiments herein. Further, the respective components in the following embodiments are, as a matter of course, replaceable and easily or substantially include the same components.

<Embodiment 1>

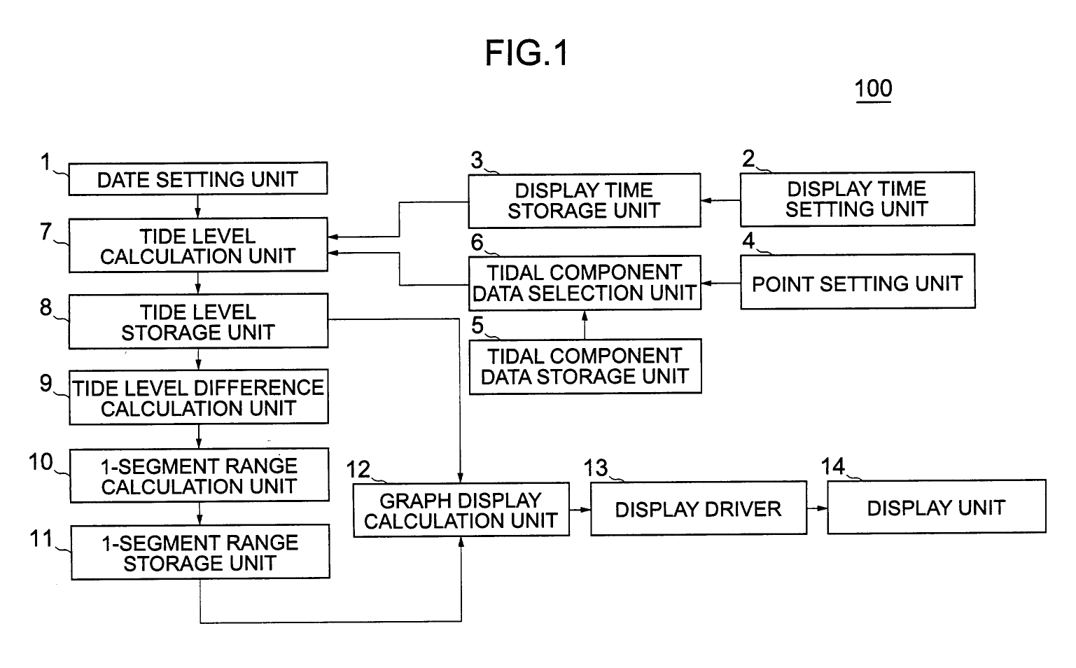

FIG. 1 is a block diagram showing an electronic tide meter in an embodiment of the present invention. This electronic tide meter 100 includes a date setting unit 1 for setting a date on which a tide is to be calculated, a display time setting unit 2 for setting which time interval is used for displaying the tide, a display time storage unit 3 for storing this display time, a point setting unit 4 for setting a point at which the tide is to be calculated, a tidal component data storage unit 5 stored with tidal component data at every point, a tidal component data selection unit 6 for selecting from the tidal component data storage unit 5 the tidal component data at the point set by the point setting unit 4, a tide level calculation unit 7 for calculating a tide level at the time interval on the basis of the date and the point, a tide level storage unit 8 for storing a tide level as a result of the calculation, a tide level difference calculation unit 9 for calculating a tide level difference between a maximum tide level and a minimum tide level from the calculated tide level, a 1-segment range calculation unit 10 for calculating a range of a tide level per segment from the calculated tide level, a 1-segment range storage unit 11 for storing a range of the tide level per segment, a graph display calculation unit 12 for executing an arithmetic process for a tide graph based on the tide level and the range of the tide per segment so as to dynamically display the tide graph, a display driver 13, and a display unit 14 such as a liquid crystal panel.

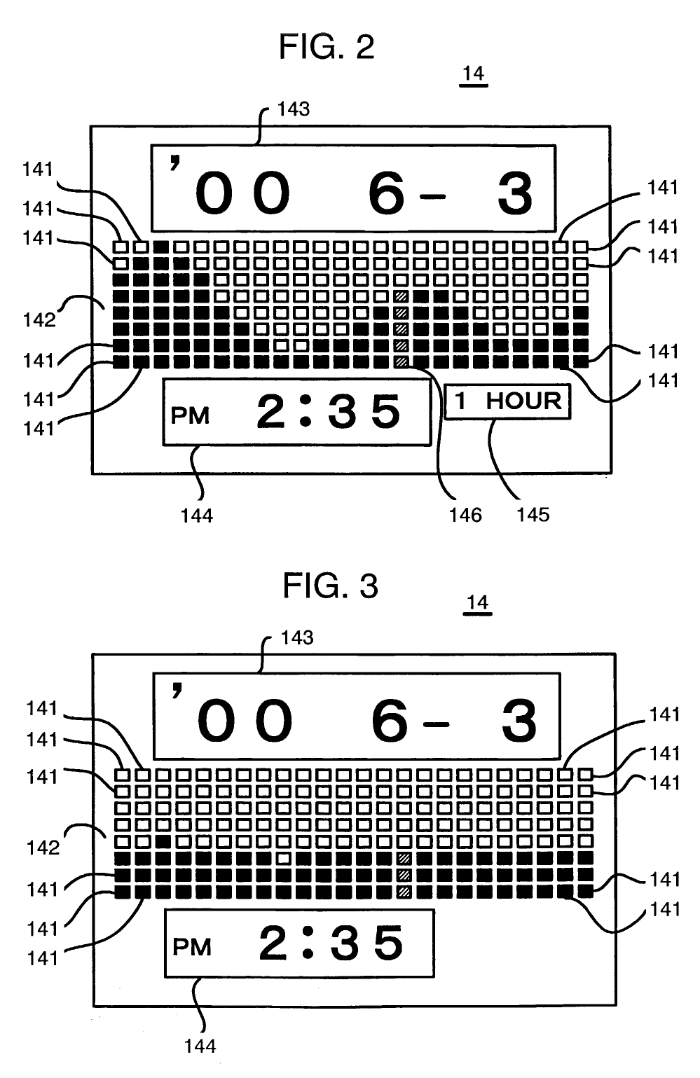

The display unit 14 has, as shown in FIG. 2, a tide graph display area 142 containing an axis of abscissa for time and an axis of ordinate for tide, and formed with a plurality of segments 141 in matrix, a date display box 143, a time display box 144 and a set time display box 145. Further, each of the units described above is constructed of a CPU (Central Processing Unit), a memory and a storage unit that constitute the electronic tide meter 100, and may also be what actualizes a function thereof by downloading from the storage unit into the memory and executing a program for actualizing the function of each unit such as a harmonic dissolving method for estimating the tide. Note that the storage unit be constructed of a non-volatile memory such as a hard disk device, a magneto-optic disk device, or a flash memory, a read-only storage medium such as a CD-ROM, a volatile memory such as a RAM (Random Access Memory), or a combination thereof.

A user inputs a date on which the user desires to calculate a tide through an unillustrated input module of the date setting unit 1. Note that a time other than the date can be also set. This time setting enables a time elapsed since an arbitrary time on the desire-to-display date to be displayed. Moreover, the user inputs a point at which the user desires to calculate the tide through the point setting unit 4. Point data are hierarchically stored, wherein the world is at first divided into several broad areas that are each stored as a major category, and the points contained in the major category of area are each stored as a minor category. The user selects a point from the hierarchized data. The user specifies a comparatively broad area, for instance, “East Asia”, “Oceania” etc, and, if “East Asia” is specified, subsequently specifies a minor category thereunder such as “Okinawa” and “Miyazaki”, thereby setting the point. Note that the hierarchical structure may contain three or more categories, and the data in greater detail can thus be stored.

The tidal component data storage unit 5 is stored with the tidal component data at the coasts and ports throughout the world, and the tidal component data selection unit 6 selectively reads the tidal component data at the point inputted. Next, in the display time setting unit 2, the user inputs a display time and stores the display time in the display time storage unit 3. This display time indicates a time corresponding to one segment 141 along the axis of abscissa for time. The display time setting unit 2 sets one segment 141 to, e.g., 30 min, one hour, 12 hours and so on.

The tide level calculation unit 7 calculates a tide level at each set time on the basis of the date and the tidal component data. The tide level is calculated at the set time interval, and a result of the calculation is stored in the tide level storage unit 8. Further, the calculation of the tide level involves the use of the known harmonic dissolving method, and the program thereof is stored in the memory of the electronic tide meter. Note that the tide levels themselves at the respective points throughout the world are stored as tide level data, and the tide level is obtained by reading the tide level data at the set point (a method of which is not illustrated herein) other than executing the tide level calculation method.

Subsequently, the tide level difference calculation unit 9 obtains a maximum tide level difference between the respective tide levels calculated throughout the day. This tide level difference is obtained as a difference between a maximum value and a minimum value that are extracted from the tide levels obtained. Note that the difference between the maximum value and the minimum value throughout the set day is herein obtained. According to the present invention, however, the data may be dynamically displayed within the range displayed, and it is therefore preferable that the maximum and minimum values of the tide levels not within one day but based on at least the range actually displayed, are obtained and a difference therebetween is set as a tide level difference.

Next, the 1-segment range calculation unit 10 divides the thus obtained tide level difference by a segment count along the tide-level-axis, thereby determining a tide level range of every segment 141. This tide level range is stored in the 1-segment range storage unit 11. At this point of time, the tide level range of one segment with respect to the previously displayed content in the 1-segment range storage unit 11, is rewritten into a tide level range of one segment with respect to a content displayed next. With this contrivance, the tide level range of one segment is changed, and the data can be dynamically displayed in a way that utilizes the display area along the tide-level-axis of the tide graph display area 142 to the full.

The graph display calculation unit 12 performs calculations for displaying a graph based on the tide levels stored in the tide level storage unit 8 and the tide level range covered by one segment 141 stored in the 1-segment range storage unit 11. A result thereof is transmitted to the display driver 13, and a tide graph is displayed on the display unit 14. The display unit 14 may be exemplified such as a liquid crystal panel, an EL (electro-luminescence) display, or an LED (light emitting diode) display.

FIG. 2 shows a specific example of the content displayed on the display unit 14. This display unit 14 is constructed of the liquid crystal panel. The tide graph display area 142 takes such a configuration that the horizontal time-axis is segmented by 24 pieces of segments 141 while the vertical tide-level-axis is segmented by 8 pieces of segments 141, wherein the 8 segments 141 are displayed in black when the tide level takes the maximum value, and one single segment 141 is displayed in black when the tide level takes the minimum value. Further, a time (one hour in FIG. 2) corresponding to one segment 141 on the time-axis is displayed in the set time display box 145 under the tide graph display area 142, and a date in the tide graph is displayed in the date display box 143. Note that if the present time falls within the display range on the time-axis, a black-displayed segment row 146 corresponding to the present time is blinked on and off. In FIG. 2, it is 2:35 p.m., and hence the fifteenth black-displayed segment row 146 counted from the left is blinked on and off. This contrivance enables the user to easily grasp a state of the tide at the present.

If contrived as described above, the tide level difference can be dynamically displayed even when the display area on the display unit 14 is limited, and a visual recognizability of the user can be enhanced. By contrast, in the case of displaying it on the same date and at the same point without changing the range, as shown in FIG. 3, the tide graph becomes comparatively flat, resulting in a less dynamic display. It is to be noted that FIG. 3 is the diagram showing a display example for reference, and this is not necessarily admitted to be known.

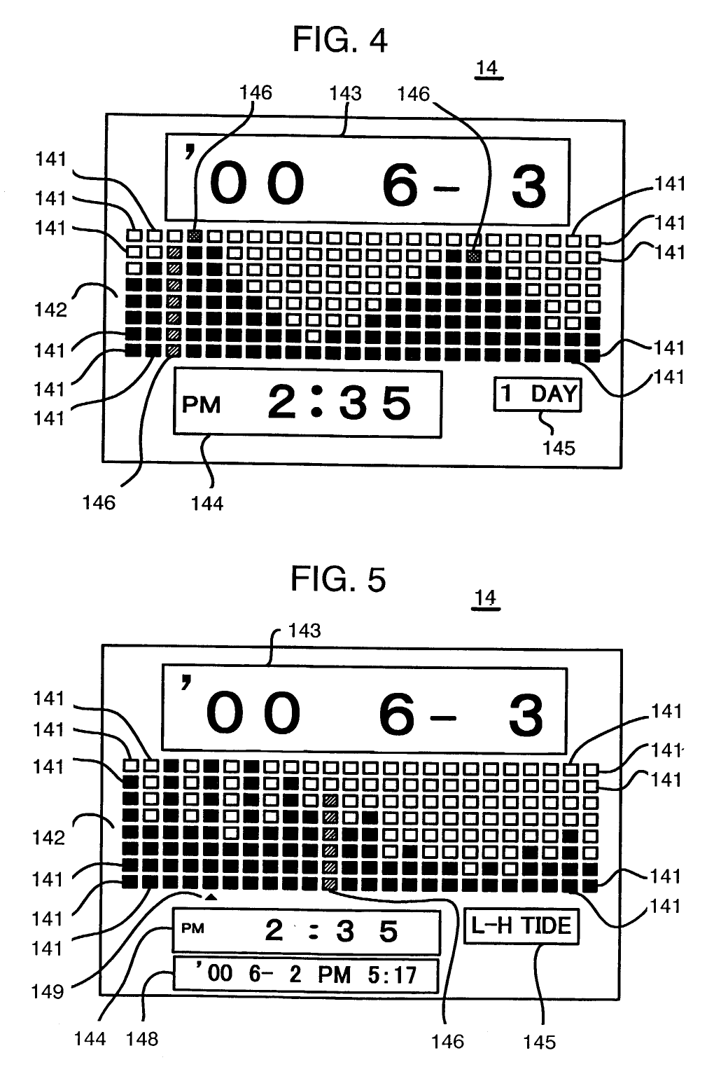

Further, a spring tide appears with a period of about 2 weeks at the intervals of the new moon and the full moon, wherein a difference between high and low tides is maximized. A neap tide appears with a period of about 2 weeks when the moon phases to its first quarter or last quarter, wherein the difference between the high and low tides is minimized. In particular, the user might want to know when the spring tide appears. In this case, the tide graph can be structured in a way that sets, as shown in FIG. 4, one segment 141 along the time-axis as one day and displays a maximum tide difference among those for totally 24 days. To be specific, this can be attained by the display time setting unit 2 that sets one day (24 hours). At this time, [1 day] is displayed in the set time display box 145 as a period of time corresponding to one segment 141 along the time-axis. Then, the black-displayed segment row 146 corresponding to the present date is blinked on and off. Further, a one-day tide level displayed at this time is a maximum tide level difference throughout one day.

Next, the tide level difference calculation unit 9 obtains a maximum tide level difference among the respective calculated maximum tide level differences for 24 days. The tide level difference is obtained as a difference between the maximum value and the minimum value which are extracted from the calculated maximum tide level differences of the respective days. Then, the 1-segment range calculation unit 10 divides the thus obtained tide level difference by a segment count of the segments along the tide-level-axis, thereby determining a range of the tide level per segment 141. This tide level range is stored in the 1-segment range storage unit 11. The tide level range of one segment is thus changed, and it is possible to attain the dynamic display utilizing the display area along the tide-level-axis of the tide graph display area 142 to the full. Note that the graph display calculation unit 12 may blink on and off only the uppermost black-displayed segment corresponding to the day of the spring tide as in the case of a segment display 147.

With this display on a day-by-day basis, the user can comprehensively predict as by a bird's-eye view how the tide will change without sending the screen, and is therefore able to grasp a timing of the spring tide, which is useful for examining a schedule of going, e.g., fishing or surfing. In addition, two or more days may also be allocated to one segment 141 on the time-axis.

<Embodiment 2>

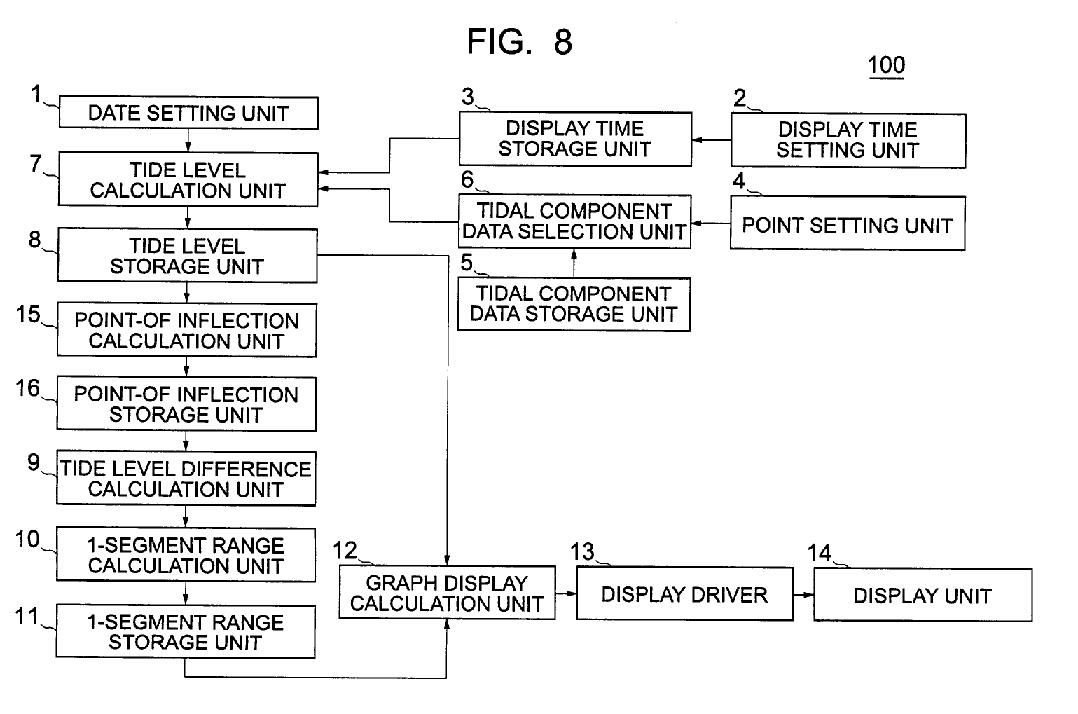

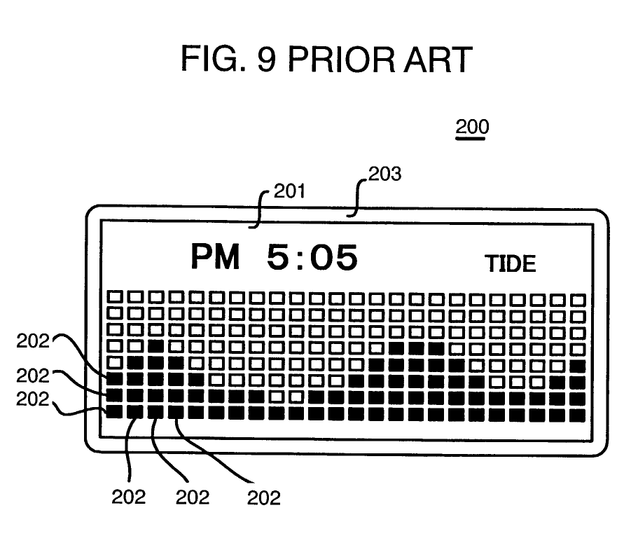

Given next is an explanation of the electronic tide meter for calculating the tide level difference by use of a point of inflection in a second embodiment. FIG. 8 is a block diagram showing the electronic tide meter in the second embodiment of the present invention. A different point from FIG. 1 is that a point-of-inflection calculation unit 15 and a point-of-inflection storage unit 16 are provided between the tide level storage unit 8 and the tide level calculation unit 9. The components marked with the same numerals as those in FIG. 1 are the same as those in FIG. 1, and therefore their explanations are omitted.

The point-of-inflection calculation unit 15 calculates a point of inflection at which there changes the tide level stored in the tide level storage unit 8. If the set time is set at a time interval as short as, e.g., 1 min and when calculating the tide level at this time interval, there is almost no contradiction between a high tide time, a low tide time and the time interval. If the set time is set at a time interval as long as one hour, the time interval might contain a low tide time and a high tide time. If so, the tide levels of the high and low tides can not be displayed. When the point-of-inflection calculation unit 15 judges that the set time interval contains the low tide and the high tide, i.e., a point of inflection, the tide level is obtained at a time interval shorter in duration than the set time. For instance, in the case of scheming to display the tide level at the 1-hour interval and therefore setting the time interval to one hour, the point-of-inflection calculation unit 15, when judging that the point of inflection exists during one hour, calculates a point of inflection by obtaining the tide level at a 20-min interval. It is preferable that the short interval be 1 min through about 30 min.

The point-of-inflection storage unit 16 is stored with the point of inflection calculated by the point-of-inflection calculation unit 15. Based on this point of inflection, the tide level calculation unit 9 calculates the maximum and minimum values of the tide levels.

Further, only the high tide and the low tide may also be displayed for obtaining a tide level difference. FIG. 5 is an explanatory diagram showing an example where only the high and low tides are displayed on the display area. It is generally known that the high and low tides each appear twice a day. Herein, if the user desires to know times when the high and low tides appear, only the high and low tides are displayed. The user sets to display the high and low tides through the display time setting unit 2. The tide level calculation unit 7 monitors a change of the tide level on a time base and calculates a point of inflection of this tide level, whereby the high and low tides can be easily acquired. A crest of the point of inflection indicates the high tide, while a bottom thereof indicates the low tide.

Next, after obtaining the low and high tides, the maximum and minimum values of the tide levels of the high and low tides are calculated, and a difference therebetween is obtained as a tide level difference. In this case, the maximum and minimum values are obtained within a range that can be displayed in the tide graph display area 142. Then, the tide level difference obtained by the 1-segment range calculation unit 10 is divided by the segment count along the tide-level-axis, thereby determining the tide level range per segment 141. This tide level range is stored in the 1-segment range storage unit 11. This contrivance makes it possible to attain the dynamic display utilizing the display area along the tide-level-axis of the tide graph display area 142 to the full even in the case of displaying the low tide and the high tide.

Note that the high and low tides each appear twice or more a day depending on the point, and hence there is a case where the time per segment differs at every point. Further, [L-HTIDE] implying the low and high tides is displayed in the set time display box 145.

Moreover, in the case of displaying the low and high tides, it is unknown what time the low or high tide appears, so that a high/low tide time display box 148 is provided for displaying it. Further, an indication symbol 149 for indicating the high or low tide as a target, is displayed under the tide graph. The high/low tide time display can be changed over by operating a button from the outside. To be specific, each time the user presses the button, the indication symbol 149 moves from the left-sided segment in the tide graph, and the time indicated by this indication symbol 149 is displayed in the high/low tide time display box 148. Note that the high/low tide time display box 148 can serve as the time display box 144. In this case, it is preferable that [L-H] for indicating the low and high tides be displayed in order to distinguish between the time display and the high/low tide display. It is to be noted that the black-displayed segment row 146 corresponding to the present date is blinked on and off.

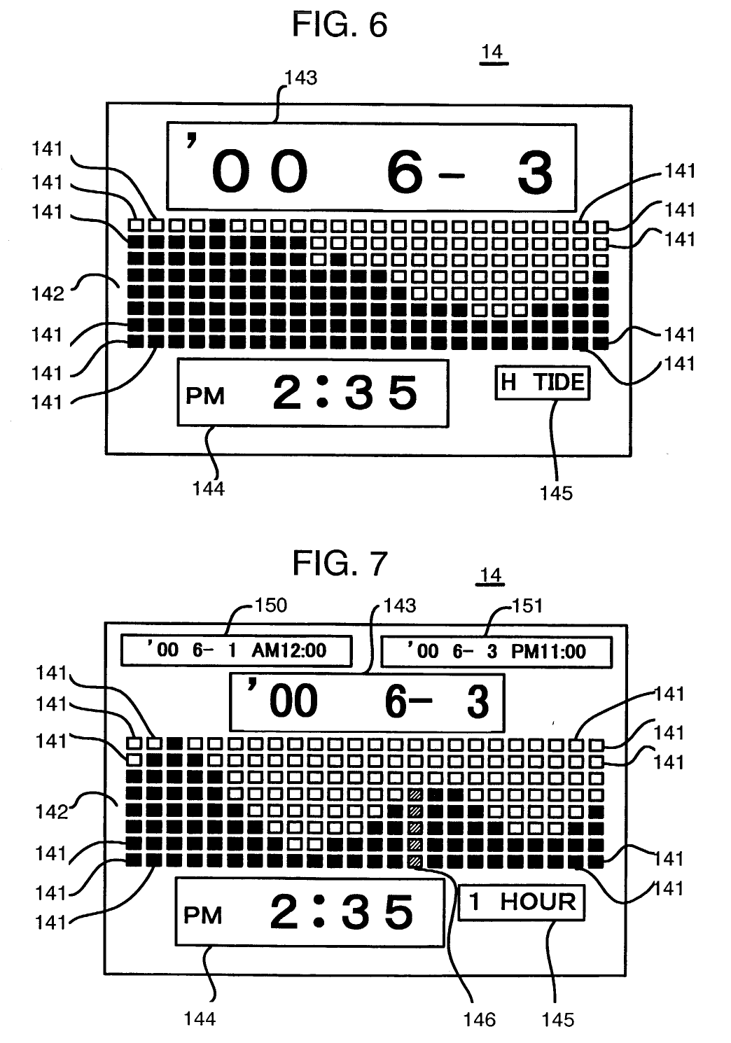

Further, FIG. 6 shows one example where only the high tide is displayed in the display unit. Only the high tide can be also displayed in the same way as FIG. 5 illustrates. Note that [H TIDE] indicating the high tide is displayed in the set time display box 145. Incidentally, though not illustrated, only the low tide can be also, as a matter of course, displayed in the same way as the above-mentioned.

Moreover, the first and second embodiments have dealt with the case of examining the schedule of going fishing and surfing, and FIG. 7 shows one example of a display content in the case of desiring to view a tidal trend batchwise during a certain period. A date/time 150 for starting obtaining the tide and a date/time 151 for finishing obtaining the tide, are inputted through setting by the date setting unit 1. In FIG. 7, the starting date/time is 12:00 a.m., Jun. 1, 2000, and the finishing date/time is 11:00 p.m., Jun. 3, 2000. Further, this is a case where the display time setting unit 2 sets the display time to one hour. A tide level difference is calculated based on these input conditions and stored in the tide level storage unit 8. Then, a 1-segment range is calculated, a result of this calculation is stored in the 1-segment range storage unit 11, and a content thereof is displayed. At this time, the time-axis is limited to display batchwise only the 24 segments (24 hours in FIG. 7), and therefore the segments are displayed in a way that consecutively scrolls them. Alternatively, the display may also be moved segment by segment each time, though not illustrated, a tide display button is pressed. If displayed in this mode, the user is able to scroll with no waiting time related to the calculation time and therefore measure the tide without any stress.

Note that the invention described above is useful for a mobile electronic equipment of which the display unit has a small areal size. This is because especially a wristwatch and a mobile telephone each have a limit in size of the display unit, and therefore the detailed tide graph can not be displayed on a large screen. Further, the present invention can be also applied to a case where the program containing the algorithm described above is installed into a computer. Namely, the functions of the respective units (marked with 1 through 12) can be actualized by installing the program containing the algorithm described above into a memory of the mobile personal computer or the mobile telephone, and it therefore follows that the program functions substantially as the electronic tide meter.

As discussed above, in the electronic tide meter according to the present invention, when displaying the tide graph defined by the time-axis and the tide-level-axis and drawn by the plurality of segments arranged in matrix, the tide level is obtained at the interval of the set time on the basis of the tide obtaining date/time and point and the tidal component data at this point, the tide level difference is calculated from the difference between the maximum value and the minimum value of the tide levels within at least the display range of the display means, the tide level range displayed by one segment is obtained by dividing this tide level difference by the segment count along the tide-level-axis, and the tide level range is changed, whereby the display content can be dynamically displayed.

Further, in the electronic tide meter according to the present invention, the tide-level obtaining means obtains the tide level at the interval of the set date on the basis of the tide level obtaining date/time and point and the tidal component data at this point, and it is therefore easy to detect a tide condition matching with the condition desired by the user.

Moreover, in the electronic tide meter according to the present invention, when displaying the tide graph of the high or low tide defined by the time-axis and the tide-level-axis and drawn by the plurality of segments arranged in matrix, the tide level is obtained at the interval of the set time on the basis of the tide obtaining date/time and point and the tidal component data at this point, the point of inflection of the tide level is obtained, and the high or low tide is obtained based on this point of inflection. Then, the tide level difference is calculated from the difference between the maximum value and the minimum value of the tide levels of the high or low tide within at least the display range of the display means, the tide level range displayed by one segment is obtained by dividing this tide level difference by the segment count along the tide-level-axis, and the tide level range is changed. Thus, the low or high tide defined as a particularly important piece of information can be displayed dynamically.

Further, the date/time for starting obtaining the tide and date/time for finishing obtaining the tide, are set as to the date and time when the tide obtaining means obtains the tide, and hence the user can save a labor for sending the display on the day-by-day basis.

What is claimed is:

1. An electronic tide meter comprising:
display means for displaying a tide graph defined by a time-axis and a tide-level-axis and configured by a plurality of segments in matrix;
tide level obtaining means for obtaining a tide level at an interval of a set time on the basis of a date/time and a point for obtaining tide and tidal component data at said point;
tide level difference calculating means for calculating a tide level difference from said tide levels obtained by said tide level obtaining means; and
segment range changing means for obtaining a tide level range displayed by one segment by dividing the tide level difference calculated by said tide level difference calculating means by a segment count of segments along said tide-level-axis of said display means and changing said tide level range.

2. An electronic tide meter according to claim 1, comprising:
point-of-inflection calculating means for calculating a point of inflection at which said tide level obtained by said tide level obtaining means changes; and
point-of-inflection storage means for storing said point of inflection calculated by said point-of-inflection calculating means,
wherein said tide level difference calculating means calculates a tide level difference from a maximum value and a minimum value of said point of inflection.

3. An electronic tide meter according to claim 2, wherein said point-of-inflection calculating means calculates said point of inflection of said tide level at a time interval shorter than a time interval set by said tide level obtaining means.

4. An electronic tide meter according to claim 1, wherein said tide level obtaining means obtains a tide level from said tidal component data at an interval of one hour.

5. An electronic tide meter according to claim 1, wherein said tide level obtaining means obtains a tide level from said tidal component data at an interval of a set day.

6. An electronic tide meter according to claim 1, wherein said tide level obtaining means sets at least one of a date/time for starting obtaining from said tidal component data and a date/time for finishing obtaining from said tidal component data.

7. An electronic tide meter comprising:
a display to display a tide graph defined by a time-axis and a tide-level-axis and configured by a plurality of segments in matrix;
a tide level obtaining circuit to obtain a tide level at an interval of a set time on the basis of a date/time and a point for obtaining tide and tidal component data at said point;
a tide level difference calculator to calculate a tide level difference from said tide levels obtained by said tide level obtaining circuit; and
a segment range changing circuit to obtain a tide level range displayed by one segment by dividing the tide level difference calculated by said tide level difference calculator by a segment count of segments along said tide-level-axis of said display and changing said tide level range.
